(19) United States
(12) Patent Application Publication
(10) Pub. No.: US 2023/0160859 A1
(43) Pub. Date: May 25, 2023

(54) IDENTIFICATION APPARATUS, IDENTIFICATION METHOD, AND IDENTIFICATION PROGRAM

(71) Applicant: NIPPON TELEGRAPH AND TELEPHONE CORPORATION, Tokyo (JP)

(72) Inventor: Yuki KUBO, Musashino-shi, Tokyo (JP)

(73) Assignee: NIPPON TELEGRAPH AND TELEPHONE CORPORATION, Tokyo (JP)

(21) Appl. No.: 17/922,782

(22) PCT Filed: May 11, 2020
(86) PCT No.: PCT/JP2020/018813

§ 371 Date: Nov. 1, 2022

(51) Int. Cl. G01N 29/44; G06F 3/01; G01N 29/24; G01N 29/04

(52) U.S. Cl. CPC G01N 29/4481; G06F 3/014; G01N 29/2437; G01N 29/04

(57) ABSTRACT

An identification device according to an embodiment includes: a sensor that measures a grasping state of a grasped object as an identification target; a position information acquisition unit that acquires position information of a sensor wearer who is wearing the sensor; and an identification unit that identifies the grasped object that is grasped by the sensor wearer based on the grasping state measured by the sensor and the position information acquired by the position information acquisition unit.

### TECHNICAL FIELD

Embodiments of the present invention relate to an identification device, an identification method, and an identification program.

### BACKGROUND ART

Non-Patent Literature 1 discloses a method that uses a glove sensor worn by a user to detect an object the user is grasping based on a difference in the contact face between the object and the hand that varies depending on the way of grasping the object that is a three-dimensional object.

### CITATION LIST

### Non-Patent Literature

Non-Patent Literature 1: Subramanian Sundaram, Petr Kellnhofer, Yunzhu Li, Jun-Yan Zhu, Antonio Torralba, Wojciech Matusik, “Learning the signatures of the human grasp using a scalable tactile glove”, Nature volume 569, pages 698-702 (2019)

### SUMMARY OF THE INVENTION

### Technical Problem

With the method disclosed in Non-Patent Literature 1, however, measurement data becomes similar when objects of similar shapes are grasped. Therefore, it is difficult to discriminate such objects from each other.

The present invention is designed to provide a technique for enabling discrimination of the grasped objects having similar shapes.

### Means for Solving the Problem

In order to overcome such an issue, an identification device according to one aspect of the present invention includes: a sensor that measures a grasping state of a grasped object as an identification target; a position information acquisition unit that acquires position information of a sensor wearer who is wearing the sensor; and an identification unit that identifies the grasped object that is grasped by the sensor wearer based on the grasping state measured by the sensor and the position information acquired by the position information acquisition unit.

### Effects of the Invention

According to one aspect of the present invention, it is possible to provide the technique for enabling discrimination of the grasped objects having similar shapes by using additional information that is the position information.

### BRIEF DESCRIPTION OF DRAWINGS

FIG. 1 is a block diagram illustrating an example of a configuration of an identification device according to an embodiment of the present invention.

FIG. 2 is a diagram illustrating an example of a hardware configuration of an information processing device that configures a part of the identification device.

FIG. 3 is a flowchart illustrating an example of a processing operation related to an analysis model learning performed in the information processing device.

FIG. 4 is a flowchart illustrating an example of a processing operation related to identification of a grasped object performed in the information processing device.

### DESCRIPTION OF EMBODIMENTS

Hereinafter, an embodiment related to the present invention will be described with reference to the accompanying drawings.

Note that the embodiment will be described by referring to a case of an identification device that analyzes acoustic spectra acquired by analyzing the vibrations propagating through the inside of objects and identifies a grasped object that is an identification target based on a difference in the acoustic spectra. The identification device analyzes the resonance characteristic that changes depending on the shape, material, boundary conditions and the like by the acoustic spectra, and identifies the grasped object as the identification target based on the difference in the spectra.

Furthermore, the identification device generates classification models by using data of all objects to be identification targets that can be selected arbitrarily. Thus, according to the difference, the identification device is not only capable of determining whether the object of the identification target is a certain target A but also capable of discriminating which object the object of the identification target is. That is, the identification device is capable of discriminating whether the object of the identification target is the target A, a target B, or a target C, for example.

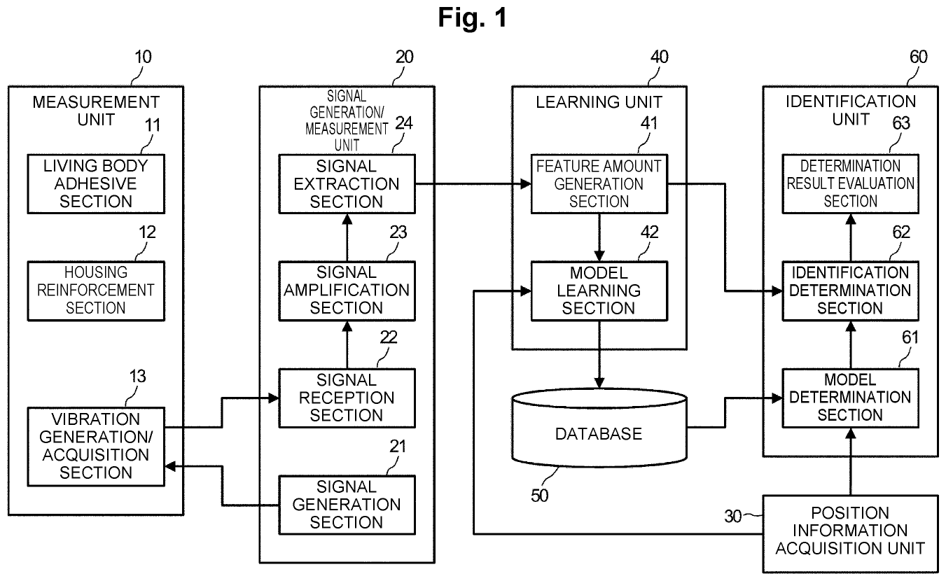

FIG. 1 is a block diagram illustrating an example of the configuration of the identification device according to the embodiment of the present invention. The identification device includes a measurement unit 10, a signal generation/measurement unit 20, a position information acquisition unit 30, a learning unit 40, a database 50, and an identification unit 60.

Note here that the measurement unit 10 is a sensor that measures a grasping state of a grasped object as the identification target, and it is also a section for loading the sensor to a living body. The measurement unit 10 includes three functional blocks that are a living body adhesion section 11, a housing reinforcement section 12, and a vibration generation/acquisition section 13.

The living body adhesion section 11 affixes the vibration generation/acquisition section 13 as the sensor to the living body. There is no specific limit set for the method for implementing the living body adhesion section 11, as long as it has viscosity and can be fixed to the skin of the living body. Examples thereof may be an adhesive tape for living bodies, and the like.

The housing reinforcement section 12 reinforces the strength of the vibration generation/acquisition section 13 in order to continuously use the vibration generation/acquisition section 13.

The vibration generation/acquisition section 13 is a sensor that measures the grasping state of the grasped object as the identification target, and it is a sensor capable of measuring a state of fingers, for example. The output of the sensor changes depending on the grasping postures of the hand and fingers corresponding to objects to be grasped. The vibration generation/acquisition section 13 includes an audio interface, and two piezoelectric elements which are capable of generating/acquiring arbitrary vibrations and not in contact with each other, for example. The piezoelectric elements can be implemented by piezo elements, for example. One of the piezoelectric elements generates a vibration having a frequency characteristic same as that of a signal (referred to as a drive signal hereinafter) generated by the signal generation/measurement unit 20. The other piezoelectric element receives the vibration. A received vibration signal (referred to as a reaction signal hereinafter) is transmitted to the signal generation/measurement unit 20. As long as it is a mechanism that is capable of propagating the vibration while being in contact with the learning target, that is, the object as a registration target or the object as an identification target, there is no specific limit set for the mode and material thereof.

Furthermore, the signal generation/measurement unit 20 generates a drive signal having an arbitrary frequency characteristic, inputs it to the piezoelectric element of the vibration generation/acquisition section 13 of the measurement unit 10, and receives a reaction signal from the vibration generation/acquisition section 13. The signal generation/measurement unit 20 can be configured with an information processing device such as a microcomputer, a personal computer (abbreviated as PC hereinafter), or the like. As the requirements for the reaction signals, there is no specific limit set for the mode and kind of vibration as long as it is the vibration having the frequency characteristic as that of audio signals. The signal generation/measurement unit 20 includes four functional blocks that are a signal generation section 21, a signal reception section 22, a signal amplification section 23, and a signal extraction section 24.

The signal generation section 21 generates the drive signal to be input to the vibration generation/acquisition section 13 of the measurement unit 10.

The signal reception section 22 acquires the reaction signal from the vibration generation/acquisition section 13 of the measurement unit 10.

The signal amplification section 23 amplifies the reaction signal acquired by the signal reception section 22.

The signal extraction section 24 extracts the reaction signal amplified in the signal amplification section 23 at regular time intervals, and outputs it to the learning unit 40.

While the vibration generation/acquisition section 13 herein is described to use the piezoelectric elements, the mode thereof is not specifically limited as long as it generates vibrations from electric signals and acquires electric signals from vibrations. At this time, there is no limit set for the mode for connecting the measurement unit 10 and the signal generation/measurement unit 20, as long as it has a function capable of transmitting/receiving data to/from the vibration generation/acquisition section 13. In addition, there is no specific limit set for the mode for controlling the measurement unit 10 as long as it is a mode capable of generating and receiving electric signals, and an independent microcomputer, a PC, or the like may be used.

Furthermore, the position information acquisition unit 30 acquires or specifies the position of the living body to which the vibration generation/acquisition section 13 of the measurement unit 10 as the sensor is adhered, that is, the position of the person wearing the sensor. There is no specific limit set for the mode and the method for implementing the position information acquisition unit 30, as long as it is possible to acquire or specify the position of the person wearing the sensor. For example, the position information acquisition unit 30 can acquire the position of the sensor wearer by using GPS (Global Positioning System), signal intensity of Wi-Fi access point or mobile phone wireless base station, Bluetooth (R) beacon, or the like. The position information acquisition unit 30 outputs position information indicating the acquired position to the learning unit 40 and the identification unit 60.

Furthermore, the learning unit 40 generates a feature amount for machine learning from the reaction signal transmitted from the signal extraction section 24 of the signal generation/measurement unit 20, constructs an analysis model from the generated feature amount, and registers the constructed analysis model to the database 50. The learning unit 40 can be configured with an information processing device such as a PC. The learning unit 40 includes two functional blocks that are a feature amount generation section 41 and a model learning section 42.

The feature amount generation section 41 generates the feature amount of the grasped object based on the waveform of the reaction signal acquired by the signal extraction section 24.

The model learning section 42 generates and learns the analysis model of a set of the feature amount acquired by the feature amount generation section 41 and the grasped object, and registers it to the database 50. When registering to the database 50, the model learning section 42 registers the position information from the position information acquisition unit 30 in association with the analysis model. In this manner, the model learning section 42 learns the analysis model in association with the position information.

The identification unit 60 selects the analysis model to be used from the database 50 based on the position information from the position information acquisition unit 30, and identifies the grasped object from the feature amount acquired by the feature amount generation section 41 of the learning unit 40 based on the selected analysis model. The identification unit 60 can be configured with an information processing device such as a PC. The identification unit 60 includes three functional blocks that are a model determination section 61, an identification determination section 62, and a determination result evaluation section 63.

The model determination section 61 determines the analysis model to be used based on the position information from the position information acquisition unit 30.

The identification determination section 62 inputs the feature amount generated by the feature amount generation section 41 of the learning unit 40 as the input to the analysis model to be used that is determined by the model determination section 61, and acquires a numerical value for determining the grasped object as the output.

The determination result evaluation section 63 identifies the grasped object based on the numerical value acquired by the identification determination section 62.

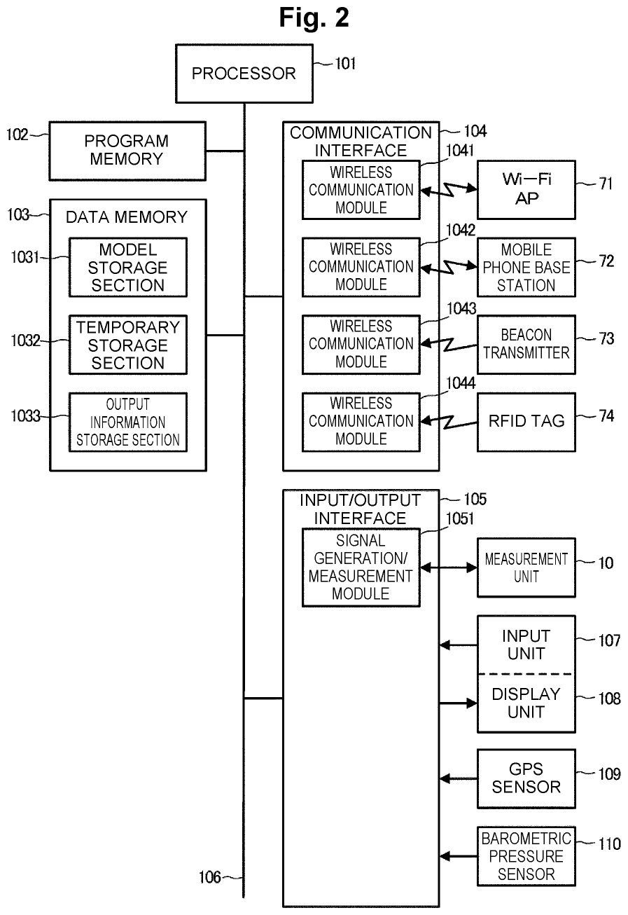

FIG. 2 is a diagram illustrating a part of the identification device of FIG. 1, and specifically it is an example of the hardware configuration of the information processing device that configures the signal generation/measurement unit 20, the position information acquisition unit 30, the learning unit 40, and the identification unit 60. As illustrated in FIG. 2, the information processing device is configured with a computer such as a PC, for example, and includes a hardware processor 101 such as a CPU (Central Processing Unit). Furthermore, in the information processing device, a program memory 102, a data memory 103, a communication interface 104, and an input/output interface 105 are connected to the processor 101 via a bus 106.

The communication interface 104 can include, for example, one or more wired or wireless communication modules. In the example of FIG. 2, four wireless communication modules 1041 to 1044 are illustrated.

The wireless communication module 1041 is, for example, capable of being wirelessly connected to a Wi-Fi access point (access point is abbreviated as AP in FIG. 2) 71, and transmitting/receiving various kinds of information by communicating with other information processing devices and server devices on a network via the Wi-Fi access point 71. The network is configured with an IP network including the Internet and an access network for accessing to the IP network. As the access network, a public wired network, a mobile phone network, a wired LAN (Local Area Network), a wireless LAN, CATV (Cable Television), or the like is used, for example. Furthermore, the wireless communication module 1041 has a function of measuring the intensity of the Wi-Fi signal, and outputs the measured signal intensity to the processor 101. Based on prior information regarding the placed position of each Wi-Fi access point 71 as a transmission device for transmitting radio signals and the intensity of a plurality of Wi-Fi reception signals, the processor 101 is capable of estimating the position of the corresponding information processing device with respect to each of the Wi-Fi Access points 71. The information processing device is disposed in the vicinity of the user grasping the object, so that it is possible to estimate the position of the user and the position of the object as a result. That is, the processor 101 and the wireless communication module 1041 can function as the position information acquisition unit 30.

The wireless communication module 1042 is wirelessly connected to a mobile phone base station 72, and is capable of transmitting/receiving various kinds of information by communicating with other information processing devices and server devices on a network via the mobile phone base station 72. Furthermore, the wireless communication module 1042 has a function of measuring the intensity of the signal received wirelessly from the mobile phone base station 72, and outputs the measured signal intensity to the processor 101. Based on prior information regarding the placed position of each mobile phone base station 72 as a transmission device for transmitting radio signals and the intensity of reception signals of a plurality of mobile phone base stations 72, the processor 101 is capable of estimating the position of the corresponding information processing device. That is, the processor 101 and the wireless communication module 1042 can also function as the position information acquisition unit 30.

The wireless communication module 1043 is a communication module that uses the near field communication technology such as Bluetooth, which measures the intensity of the beacon signal transmitted from a beacon transmitter 73 and outputs the measured signal intensity to the processor 101. The processor 101 can specify the position range of the information processing device based on prior information regarding the placed position of each beacon transmitter 37 and the intensity of at least one beacon signal. Alternatively, the processor 101 can estimate the position of the information processing device by using the prior information and the intensity of a plurality of beacon signals. Furthermore, the position information of the beacon transmitter 73 can be included in the beacon transmitted from the beacon transmitter 73, and the use of the position information makes it possible to estimate the position of the information processing device without the prior information regarding the placed position of the beacon transmitter 73. That is, the beacon transmitter 37 is not only the transmission device that transmits radio signals but also a position information transmission device that transmits position information, and the wireless communication module 1043 is a communication device that receives the position information. Therefore, the processor 101 and the wireless communication module 1043 can function as the position information acquisition unit 30.

The wireless communication module 1044 is a communication module that reads out an RFID (Radio Frequency Identifier) tag 74, which reads out information recorded on the RFID tag 74 and outputs the read-out information to the processor 101. The RFID tag 74 can have the position information recorded thereon. That is, the RFID tag 74 is the position information transmission device that transmits the position information, and the wireless communication module 1044 is the communication device that receives the position information. Therefore, the processor 101 can acquire the position of the information processing device based on the read-out position information. That is, the processor 101 and the wireless communication module 1044 can also function as the position information acquisition unit 30.

Furthermore, the measurement unit 10 is connected to the input/output interface 105. The input/output interface 105 includes a signal generation/measurement module 1051 that functions as the signal generation section 21, the signal reception section 22, and the signal amplification section 23 of the signal generation/measurement unit 20, for example.

Furthermore, an input unit 107, a display unit 108, a GPS sensor 109, and a barometric pressure sensor 110 are connected to the input/output interface 105.

For the input unit 107 and the display unit 108, it is possible to use the so-called tablet input/display device where an input detection sheet employing an electrostatic mode or a pressure mode is disposed on a display screen of a display device using liquid crystal or organic EL (Electro Luminescence), for example. Note that the input unit 107 and the display unit 108 may be configured with independent devices. The input/output interface 105 inputs operation information input via the input unit 107 to the processor 101, and displays the display information generated by the processor 101 on the display unit 108.

Note that the input unit 107 and the display unit 108 may not be connected to the input/output interface 105. The input unit 107 and the display unit 108 can exchange information with the processor 101 by including a communication unit for connecting to the communication interface 104 directly or via the network.

The GPS sensor 109 is a positioning unit that receives GPS signals and detects positions. The input/output interface 105 inputs position information indicating the positioning result of the GPS sensor 109 to the processor 101. Therefore, the position information acquisition unit 30 can include the GPS sensor 109 that is a position detection sensor for detecting the position information.

The barometric pressure sensor 110 measures the barometric pressure. The input/output interface 105 inputs barometric pressure information indicating the barometric pressure measured by the barometric pressure sensor 110 to the processor 101. The processor 101 can acquire the altitude of the information processing device based on the barometric pressure information. Based on the acquired altitude, the processor 101 can correct the position information acquired by the other structural components of the position information acquisition unit 30. That is, the processor 101, the input/output interface 105, and the barometric pressure sensor 110 can function as the position information acquisition unit 30. Therefore, the position information acquisition unit 30 can include the barometric pressure sensor 110 that is a part of the position detection sensor for detecting the position information.

Furthermore, the input/output interface 105 may have a function of reading/writing to a recording medium like a semiconductor memory such as a flash memory or may have a function of connecting to a reader/writer that has such a function of reading/writing to the recording medium. Thereby, a recording medium removable from the identification device can be used as a database that holds the analysis models. The input/output interface 105 may further have a function of connecting to other devices.

Furthermore, as for the program memory 102, a nonvolatile memory capable of writing and reading at any time such as an HDD (Hard Disk Drive) or an SSD (Solid State Drive) and a nonvolatile memory such as a ROM (Read Only Memory), for example, are used in combination as a non-transitory tangible computer readable storage medium. In the program memory 102, a program necessary for the processor 101 to execute various kinds of control processing related to the embodiment is stored. That is, the processing functional sections in each of the signal generation/measurement unit 20, the position information acquisition unit 30, the learning unit 40, and the identification unit 60 may all be implemented by causing the processor 101 to read out and execute the program stored in the program memory 102. Note that a part of or a whole part of those the processing functional sections may be implemented by other various forms including an integrated circuit such as Application Specific Integrated Circuit (ASIC), a field-programmable gate array (FPGA), or the like.

Furthermore, as for the data memory 103, the nonvolatile memory described above and a volatile memory such as a RAM (Random Access Memory), for example, are used in combination as a tangible computer readable storage medium. The data memory 103 is used for storing various kinds of data acquired and generated in the process of performing the various kinds of processing. That is, in the data memory 103, areas for storing the various kinds of data as appropriate in the process of performing the various kinds of processing are secured. As such areas, a model storage section 1031, a temporary storage section 1032, and an output information storage section 1033, for example, can be provided in the data memory 103.

In the model storage section 1031, the analysis model learned by the learning unit 40 is stored. That is, the database 50 can be configured in the model storage section 1031.

The temporary storage section 1032 stores data such as the reaction signals, the feature amounts, training data, the position information, the analysis models, and reference values acquired or generated when the processor 101 performs operations as the signal generation/measurement unit 20, the position information acquisition unit 30, the learning unit 40, and the identification unit 60.

The output information storage section 1033 stores the output information that is acquired when the processor 101 performs the operation as the identification unit 60.

Next, operations of the identification device will be described.

In the embodiment, prior to identifying the grasped object, first, the identification device generates an analysis model associated with the grasped object by using the sensor capable of measuring the state of the fingers, associates the position information with the generated analysis model, and saves it in the database 50 as registration data.

First, the vibration generation/acquisition section 13 of the measurement unit 10 is affixed to the back of the hand of the user to be the target by using the living body adhesion section 11. There is no specific limit set for the mode and kind of the vibration generated by the vibration generation/acquisition section 13, as long as it is the vibration having a frequency characteristic as that of audio signals. In the embodiment, a case of audio signals will be described as an example.

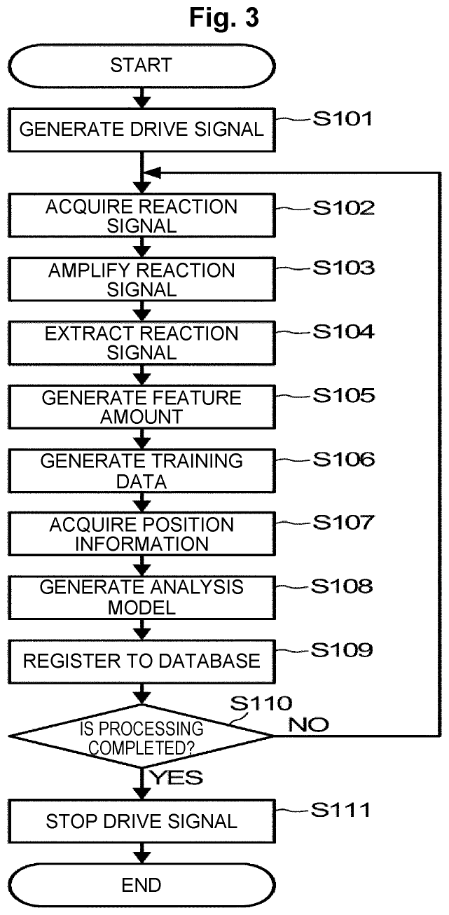

FIG. 3 is a flowchart illustrating an example of processing operations of the identification device related to learning the analysis model. The flowchart indicates the processing operation of the processor 101 of the information processing device functioning as a part of the recognition device, specifically, as the signal generation/measurement unit 20, the position information acquisition unit 30, the learning unit 40, and the identification unit 60. When there is an instruction from the input unit 107 to start learning via the input/output interface 105 after affixing the vibration generation/acquisition section 13 to the back of the hand of the user, the processor 101 starts the operation indicated in the flowchart.

First, the processor 101 generates an audio signal (drive signal) based on an arbitrarily set parameter by the signal generation/measurement module 1051 of the input/output interface 105 functioning as the signal generation section 21 of the signal generation/measurement unit 20 (step S101). The drive signal may be an ultrasonic wave sweeping from 20 kHz to 40 kHz, for example. Note, however, that there is no limit for the setting of the audio signals regarding whether or to sweep, whether or to use other frequency bands, and the like. The generated drive signal is input to the vibration generation/acquisition section 13 of the measurement unit 10.

The user grasps an object as a registration target. Thereby, a vibration is given to the object as the registration target via the vibration generation/acquisition section 13 by the drive signal generated by the signal generation/measurement module 1051 based on the parameter set in advance. The vibration generation/acquisition section 13 acquires the vibration that is given to the registration-target object and propagated through the inside and the surface of the object. Note here that the registration-target object functions as a propagation path when the vibration given from one of the piezoelectric elements of the vibration generation/acquisition section 13 is propagated to the other piezoelectric element, and the frequency characteristic of the given vibration changes in accordance with the propagation path varies.

The vibration generation/acquisition section 13 detects the vibration that is given to the object as the registration target and propagated through the inside of the object. The signal generation/measurement module 1051 of the input/output interface 105 functioning as the signal reception section 22 of the signal generation/measurement unit 20 acquires the reaction signal indicated by the detected vibration (step S102).

The signal generation/measurement module 1051 of the input/output interface 105 functioning as the signal amplification section 23 of the signal generation/measurement unit 20 amplifies the acquired reaction signal (step S103). This is because the vibration passed through the registration-target object is damped, so that it is necessary to perform amplification until it reaches the level capable of performing the processing. The amplified reaction signal is stored in the temporary storage section 1032 of the data memory 103.

The processor 101 then functions as the signal extraction section 24 of the signal generation/measurement unit 20 to extract the reaction signal stored in the temporary storage section 1032 at regular time intervals (step S104). There is no specific limit set for the number of signal samples. The extracted reaction signal is stored in the temporary storage section 1032 of the data memory 103.

Then, the processor 101 functions as the feature amount generation section 41 of the learning unit 40 to perform following processing operations.

First, the processor 101 performs FFT (Fast Fourier Transform), for example, for the extracted reaction signal stored in the temporary storage section 1032 to generate the feature amount indicating the audio frequency characteristic and the like of the object (step S105). The generated feature amount is stored in the temporary storage section 1032 of the data memory 103.

Then, the processor 101 gives a unique identifier (hereinafter, referred to as an object ID) to the generated feature amount, and generates training data having the feature amount and the object ID as a set (step S106). The generated training data is stored in the temporary storage section 1032 of the data memory 103. Furthermore, the processor 101 may extract the registration data generated in advance from the database 50 configured in the model storage section 1031 of the data memory 103, and generate the training data by using it.

Then, the processor 101 functions as the model learning section 42 of the learning unit 40 to perform following processing operations.

First, the processor 101 acquires position information, and stores the acquired position information to the temporary storage section 1032 of the data memory 103 (step S107). Specifically, the processor 101 measures the intensity of the Wi-Fi signal for a plurality of Wi-Fi access points 71 by the wireless communication module 1041 of the communication interface 104 to acquire the position information. Alternatively, the processor 101 measures the intensity of the radio signal for a plurality of mobile phone base stations 72 by the wireless communication module 1042 of the communication interface 104 to acquire the position information. Alternatively, the processor 101 measures the intensity of the beacon signal transmitted from at least one beacon transmitter 73 by the wireless communication module 1043 of the communication interface 104 to acquire the position information. Alternatively, the processor 101 reads out the information recorded on the RFID tag 74 by the wireless communication module 1044 of the communication interface 104 to acquire the position information. Alternatively, the processor 101 acquires the position information by the GPS sensor 109 via the input/output interface 105. Furthermore, the processor 101 acquires the barometric pressure information from the barometric pressure sensor 110 via the input/output interface 105 to acquire the altitude information.

Note that the position information indicates the place where each object is placed at the time of learning. The position information is the information that can uniquely specify the places such as kitchen, office, kitchen at home, office kitchenette, and the like, for example, and there is no specific mode set for the position information as long as it is the information that can specify the place, such as the latitude, longitude, name of the place, and the like.

Then, the processor 101 generates and learns the analysis model having the feature amount of the training data as the input, and the object ID as the label in the training data and the reference value that is a difference with respect to the input as the output (step S108). There is no specific type set for the library used for the classification models and learning thereof as long as it is possible to achieve learning to acquire the optimal output by performing parameter tuning or the like on the training data. For example, a generally known machining learning library may be used to perform learning such that the algorithm for generating the classification models such as SVM (Support Vector Machine), a neural network, can acquire the optimal output by performing parameter tuning or the like on the training data.

As for the learning, when SVM is used as the algorithm for generating a model, for example, a score indicating similarity or the like for each label of the analysis model is output for an input. For example, when the similarity is normalized and expressed between “0” and “1”, it can be output as “1-(similarity)”.

Alternatively, when Random Forest is used in the learning as the algorithm for generating a model, for example, data is randomly extracted from training data to generate a plurality of decision trees. The number of determination results for each label of each determination tree for the input data is output. Since the higher number of determination results is better, “(the number of determination times)-(the number of determination results)” is output as a reference value.

Furthermore, other classification algorithms such as DNN (Deep Neural Network) and the like may be used for the classification algorithms. In that case, the reference value may be acquired by subtracting normalized similarity from “1” or may be acquired by returning the similarity by the reciprocal or the like of the similarity.

Furthermore, regarding the analysis model and the classification model acquired by the learning processing, the processor 101 registers the models themselves or the parameters of the models to the database 50 configured in the model storage section 1031 of the data memory 103 (step S109). At this time, as for the object ID to be learned, the processor 101 also registers the position information acquired and stored in the temporary storage section 1032 to the database 50 so as to be in a referable state.

When the learning of a single object as the registration target ends, the processor 101 determines whether there is an instruction from the input unit 107 to end the learning via the input/output interface 105 (step S110). When it is determined that there is no instruction to end the learning (NO in step S110), the processor 101 repeats the processing from step S102 described above. Thereby, it is possible to perform learning of another registration-target object in that place.

In the meantime, when it is determined that there is an instruction to end the learning (YES in step S110), the processor 101 stops generation of the drive signal by the signal generation/measurement module 1051 of the input/output interface 105 (step S111). Then, the processing operation indicated in the flowchart is ended.

Thereafter, it is possible to move to another place and perform learning in the same manner for the registration-target object in that place. In this manner described above, the analysis model is generated and learned for each place based on the associated position information. Furthermore, regarding the classification model acquired by the learning processing, the model itself or the parameter of the model is registered to the database 50.

Next, the operation of the identification device performed when grasping and identifying the object as the identification target will be described. The identification device selects an analysis model by using the position information from the analysis models registered in the database 50 or the like. Then, the generated feature amount is input to the selected analysis model to designate the grasped object from the identification targets registered in the analysis model. The specific processing thereof will be described hereinafter.

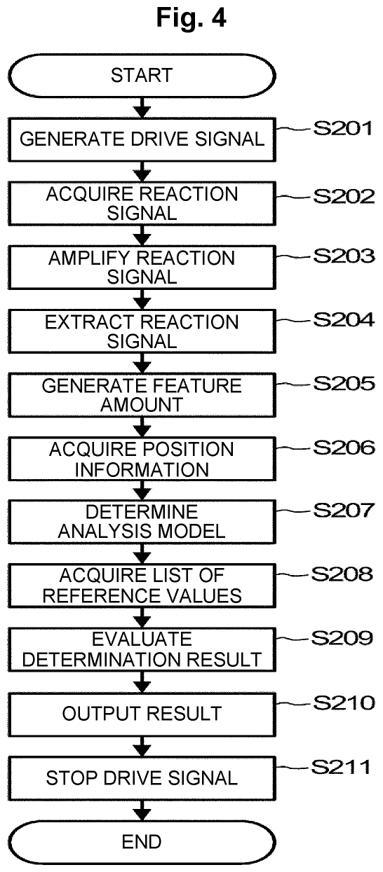

FIG. 4 is a flowchart illustrating an example of the processing operation related to identification of a single grasped object to be identified. The flowchart indicates the processing operation of the processor 101 of the information processing device functioning as a part of the recognition device, specifically, as the signal generation/measurement unit 20, the position information acquisition unit 30, the learning unit 40, and the identification unit 60. When there is an instruction from the input unit 107 to start identification via the input/output interface 105 after affixing the vibration generation/acquisition section 13 to the back of the hand of the user, the processor 101 starts the identification indicated in the flowchart.

First, the processor 101 generates the drive signal based on the arbitrarily set parameter by the signal generation/measurement module 1051 of the input/output interface 105 functioning as the signal generation section 21 of the signal generation/measurement unit 20 (step S201). The generated drive signal is input to the vibration generation/acquisition section 13 of the measurement unit 10.

The user grasps the object as the identification target. Thereby, the vibration is given to the grasped object as the identification target via the vibration generation/acquisition section 13 by the drive signal generated by the signal generation/measurement module 1051. The vibration at this time may include other frequencies mixed therein as long as the frequency included in the vibration used when generating the feature amount included in the registration data regarding the learned object registered in the database 50 (hereinafter, referred to as registered object) is included. The vibration generation/acquisition section 13 acquires the vibration that is given to the grasped object as the identification target and propagated through the inside and the surface of the grasped object. Note here that the grasped object functions as a propagation path when the vibration given from one of the piezoelectric elements of the vibration generation/acquisition section 13 is propagated to the other piezoelectric element, and the frequency characteristic of the given vibration changes in accordance with the propagation path.

The vibration generation/acquisition section 13 detects the vibration that is given to the grasped object as the identification target and propagated through the inside of the object. The signal generation/measurement module 1051 of the input/output interface 105 functioning as the signal reception section 22 of the signal generation/measurement unit 20 acquires the reaction signal indicated by the detected vibration (step S202).

The signal generation/measurement module 1051 of the input/output interface 105 functioning as the signal amplification section 23 of the signal generation/measurement unit 20 amplifies the acquired reaction signal (step S203). The amplified reaction signal is stored in the temporary storage section 1032 of the data memory 103.

The processor 101 then functions as the signal extraction section 24 of the signal generation/measurement unit 20 to extract the reaction signal stored in the temporary storage section 1032 at regular time intervals (step S204). There is no specific limit set for the number of signal samples. The extracted reaction signal is stored in the temporary storage section 1032 of the data memory 103.

Then, the processor 101 functions as the feature amount generation section 41 of the learning unit 40 to perform FFT, for example, for the extracted reaction signal stored in the temporary storage section 1032 to generate the feature amount indicating the audio frequency characteristic and the like of the object (step S205). The generated feature amount is stored in the temporary storage section 1032 of the data memory 103.

Then, the processor 101 functions as the model determination section 61 of the identification unit 60 to perform following processing operations.

First, the processor 101 acquires position information, and stores the acquired position information to the temporary storage section 1032 of the data memory 103 (step S206). Specifically, the processor 101 measures the intensity of the Wi-Fi signal for the plurality of Wi-Fi access points 71 by the wireless communication module 1041 of the communication interface 104 to acquire the position information. Alternatively, the processor 101 measures the intensity of the radio signal for the plurality of mobile phone base stations 72 by the wireless communication module 1042 of the communication interface 104 to acquire the position information. Alternatively, the processor 101 measures the intensity of the beacon signal transmitted from at least one beacon transmitter 73 by the wireless communication module 1043 of the communication interface 104 to acquire the position information. Alternatively, the processor 101 reads out the information recorded on the RFID tag 74 by the wireless communication module 1044 of the communication interface 104 to acquire the position information. Alternatively, the processor 101 acquires the position information by the GPS sensor 109 via the input/output interface 105. Furthermore, the processor 101 acquires the barometric pressure information from the barometric pressure sensor 110 via the input/output interface 105 to acquire the altitude information.

Then, the processor 101 determines an analysis model associated with the most similar position information from a large number of analysis models registered in the database 50 configured in the model storage section 1031 of the data memory 103 based on the acquired position information stored in the temporary storage section 1032 (step S207). For example, the processor 101 refers to the latitude/longitude as the acquired position information to select the analysis model associated with the position information having the closest latitude/longitude. When there is a plurality of analysis models associated with the position information, the plurality of analysis models is selected. The selected analysis models are stored in the temporary storage section 1032 of the data memory 103.

In a case where a single or a plurality of analysis models associated with the position information can be selected uniquely, there is no specific type set for the position information to be used and no specific mode set for the selection method thereof. For example, as the determination method of the analysis model, considered is a mode that uses the latitude/longitude and the type of place in combination. First, in a stage of learning the latitude/longitude, the latitude/longitude is sectioned into sections of a certain size (so-called mesh) to generate an analysis model in a unit of section. Then, the latitude/longitude representing the section is linked to the analysis model. In a stage of identification, at least a single analysis model closest to the latitude/longitude designated as the position information is used. Then, as for the types of place, an analysis model is generated for each type of place to be classified in a stage of learning the type of place. For example, as the information for specifying the place to be classified, there is the Wi-Fi access point 71 that is the information of the connection-destination network device of the information device of the user. However, there is no specific limit set for the mode thereof as long as it is the method capable of specifying the place, such as the GPS sensor 109 and the like. In the stage of identification, the place is identified from the acquired position information, and the corresponding analysis model is selected and used. While the embodiment using the latitude/longitude and the type of place in combination is described above, a mode using each of those alone may be used as well.

Then, the processor 101 functions as the identification determination section 82 of the identification unit 60, and inputs the feature amount acquired in step S205 and stored in the temporary storage section 1032 as test data to one or more analysis models stored in the temporary storage section 1032 of the data memory 103 to acquire a list of the reference values of each analysis model (step S208). The acquired lists of reference values are stored in the temporary storage section 1032 of the data memory 103.

Then, the processor 101 functions as the determination result evaluation section 63 of the identification unit 60 to specify the smallest reference value from the lists of the reference values stored in the temporary storage section 1032. The processor 101 determines that the registered object in the database 50 associated with the feature amount same as the specified reference value as the similar object. Then, the processor 101 stores the object ID of the determined registered object to the output information storage section 1033 of the data memory 103 as the identification result of the grasped object as the identification target (step S209). In the determination processing, a determination threshold value may be set for the similarity degree and the similar object may be determined only when the specified reference value is smaller than the threshold value.

Then, the processor 101 outputs and displays the object ID as the identification result stored in the output information storage section 1033 on the display unit 108 via the input/output interface 105 (step S210).

When identification of a single grasped object as the identification target ends in this manner, the processor 101 stops generation of the drive signal by the signal generation/measurement module 1051 of the input/output interface 105 (step S211). Then, the processing operation indicated in the flowchart is ended.

The identification device according to the embodiment described above includes: the vibration generation/acquisition section 13 including the sensor that measures the grasping state of the grasped object as the identification target; the position information acquisition unit 30 that acquires the position information of the sensor wearer who is wearing the sensor; and the identification unit 60 that identifies the grasped object grasped by the sensor wearer based on the grasping state measured by the sensor and the position information acquired by the position information acquisition unit 30. Therefore, by combining the position information in addition to the data acquired from the sensor indicating the grasping state of the grasped object, the identification device becomes capable of discriminating the objects of similar shapes as different objects. That is, objects of similar shapes may be different objects depending on the places (for example, kitchen, desk at home, office, and the like) where identification is to be performed. According to the place where identification is to be performed, it is possible to specify the objects existing in the place and the surroundings thereof to some extent. Therefore, by narrowing down the candidates to be the identification target by using the position information at the time of identification, the identification device can exclude the objects that have similar shapes but are in different positions from the identification target so that it is possible to decrease the probability of misidentifying the grasped object.

Furthermore, the identification device according to the embodiment further includes the database 50 where the feature amount indicating the grasping state measured by the sensor is registered by being associated with the position information acquired by the position information acquisition unit 30 for each of a plurality of registration-target objects, in which the identification unit 60: narrows the plurality of registration-target objects registered in the database 50 down to one or more candidate objects according to the position information acquired by the position information acquisition unit 30; and among the one or more narrowed down candidate objects, identifies a single candidate object having the feature amount that corresponds to the feature amount indicating the grasping state of the grasped object measured by the sensor to be the object of the identification target. As described above, by narrowing down the identification target in advance by using the position information at the time of identification, the identification device can decrease the probability of misidentifying the grasped object and also can shorten the processing time since it is not necessary to make comparison with all registration data registered in the database 50 one by one.

Furthermore, the identification device according to the embodiment further includes the learning unit 40 that registers the feature amount to the database 50 in association with the position information acquired by the position information acquisition unit 30 for each of the plurality of registration-target objects. Therefore, the identification device can associate all of the registration-target objects with the position information and also can add a new registration-target object to the database 50.

Furthermore, in the identification device according to the embodiment, the feature amount indicating the grasping state measured by the sensor includes a feature amount indicating a frequency characteristic that is based on a vibration propagated through inside of the object; the sensor generates a first vibration to be given to the object by a piezoelectric element, and acquires a detection signal corresponding to a second vibration that is propagated through the inside of the object out of the first vibration given to the object; and the identification unit 60 generates a feature amount indicating a frequency characteristic of the second vibration based on the acquired reaction signal and, among the plurality of registration-target objects registered in the database 50, identifies a single candidate object having the feature amount that corresponds to the generated feature amount to be the object of the identification target. Therefore, the identification device can have any objects where the vibration is propagated through as the object of the identification target.

Furthermore, in the identification device according to the embodiment, the database 50 stores a model in association with the position information acquired by the position information acquisition unit 30, the model having the generated feature amount of the grasped object as the identification target as input and outputting a value according to a difference between the feature amount of at least one of the identified registration-target objects and the feature amount of the grasped object in association with an identifier that is uniquely given to the grasped object; the model is learned based on the feature amount indicating the frequency characteristic of the second vibration generated based on the detection signal acquired by the sensor for each of the plurality of registration-target objects; and the identification unit 60 inputs the feature amount generated for the grasped object as the identification target to the model of the one or more narrowed down candidate objects, and determines an identifier output by being associated with a value indicating the highest relevance with the feature amount of the grasped object among values output from the model of the one or more candidate objects as the identifier of the grasped object so as to identify the grasped object. Therefore, the identification device can perform appropriate identification of the grasped object as the identification target by using the identified object.

In the identification device according to the embodiment, as the position information acquisition unit 30, it is possible to use a unit that detects the intensity of a radio signal from a transmission device that transmits the radio signal, and estimates a position with respect to the transmission device based on the detected intensity. For example, the position information acquisition unit 30 includes the wireless communication module 1041 that communicates with the Wi-Fi access points 71, the wireless communication module 1042 that communicates with the mobile phone base stations 72, and the wireless communication module 1043 that receives beacons from the beacon transmitter 73.

In the identification device according to the embodiment, the position information acquisition unit 30 can include a position detection sensor that detects the position information. The position detection sensor includes the GPS sensor 109 or the barometric pressure sensor 110, for example.

Furthermore, in the identification device according to the embodiment, the position information acquisition unit 30 can include a communication device that receives the position information transmitted from a position information transmission device. For example, the communication device includes the wireless communication module 1043 that receives the position information included in the beacon from the beacon transmitter 73 or the wireless communication module 1044 that reads out the position information recorded on the RFID tag 74.

### Another Embodiment

In the embodiment, the identification device is described to be the device that analyzes the acoustic spectra acquired by analyzing the vibrations propagating through the inside of the objects and identifies the grasped object based on the difference in the acoustic spectra. Naturally, however, the identification device may also be a device that identifies the grasped object by other methods such as using a glove sensor as disclosed in Non-Patent Literature 1, and the like, for example.

Furthermore, the information processing device configuring a part of the identification device does not need to have all of the wireless communication modules 1041 to 1044 but may simply include at least one of those. Furthermore, when the position information acquisition unit 30 is configured by using the GPS sensor 109 or the barometric pressure sensor 110, none of the wireless communication modules 1041 to 1044 may be included. The information processing device may simply include at least one of the wireless communication modules 1041 to 1044, the GPS sensor 109, and the barometric pressure sensor 110 for configuring the position information acquisition unit 30.

Alternatively, the position information acquisition unit 30 may acquire the position information from an information processing device having a GPS sensor, such as a smartphone or the like carried by the user, by wireless communication via Wi-Fi, Bluetooth, or the like. In that case, the position information acquisition unit 30 is configured with the wireless communication module 1041, 1043, or the like of the communication interface 104.

Note that the processing operations illustrated in FIG. 3 and FIG. 4 are not limited to be in the order of steps indicated therein as an example but may also be performed in the order different from the order indicated as an example and/or may be performed in parallel to other steps. For example, in the processing operation of FIG. 3, the training data generation processing of step S106 and the position information acquisition processing of step S107 may be performed in a reverse order or may be performed in parallel. Furthermore, when performing learning based on a plurality of registration-target objects without changing the position, the position information acquisition processing of step S107 may be taken out from the loop of step S102 to step S110 so as to acquire the position information only once before starting the loop. As for the processing operation of FIG. 4, the position information acquisition processing of step S206, for example, may be performed at any stages as long as it is before the analysis model is determined in step S207.

Furthermore, while the processing functional units that are the signal generation/measurement unit 20, the position information acquisition unit 30, the learning unit 40, the database 50, and the identification unit 60 are described in the embodiment to be configured by a single information processing device, those may be divided arbitrarily and configured with a plurality of information processing devices.

Furthermore, the database 50 may be formed in an information processing device or a server device that is different from the information processing device configuring the identification device and is capable of having communication via the network by the communication interface 104.

Moreover, an information processing device different from the identification device may be used for learning the registered object in the database 50, and the identification device may perform identification of the grasped object as the identification target by using the registration data regarding the registered object in the database 50.

Furthermore, the method described in the embodiment can be distributed as a program (software means) that can be executed by a calculator (computer) by being stored in a recording medium such as a magnetic disk (floppy (R) disk, hard disk, or the like), an optical disk (CD-ROM, DVD, MO, or the like), a semiconductor memory (ROM, RAM, flash memory, or the like), for example, or may be distributed by being transmitted from a communication medium. Note that the program stored on the medium side also includes a setting program for configuring, in the calculator, the software means (including not only the execution program but also tables and data structures) to be executed by the calculator. The calculator implementing the device executes the above-described processing by reading out the program recorded on the recording medium or building the software means by the setting program in some cases, and by controlling the operation thereof by the software means. The recording medium discussed in the current Description is not limited to those used for distribution but also includes a storage medium such as a magnetic disk, a semiconductor memory, or the like provided inside the calculator or provided to a device connected via a network.

In short, the present invention is not limited by the above-described embodiments but various modifications are possible without departing from the scope thereof. Furthermore, each of the embodiments may be combined as appropriate when possible, and a combined effect can be acquired in such a case. Moreover, the embodiments include the invention of various stages, and various kinds of inventions can be extracted by appropriately combining a plurality of disclosed structural elements.

### REFERENCE SIGNS LIST

10 Measurement unit

11 Living body adhesion section

12 Housing reinforcement section

13 Vibration generation/acquisition section

20 Signal generation/measurement unit

21 Signal generation section

22 Signal reception section

23 Signal amplification section

24 Signal extraction section

30 Position information acquisition unit

40 Learning unit

41 Feature amount generation section

42 Model learning section

50 Database

60 Identification unit

61 Model determination section

62 Identification determination section

63 Determination result evaluation section

71 Wi-Fi access point

72 Mobile phone base station

73 Beacon transmitter1

74 RFID tag

101 Processor

102 Program memory

103 Data memory

1031 Model storage section

1032 Temporary storage section

1033 Output information storage section

104 Communication interface

1041 to 1044 Wireless communication module

105 Input/output interface

1051 Signal generation/measurement module

106 Bus

107 Input unit

108 Display unit

109 GPS sensor

110 Barometric pressure sensor

1. An identification device comprising:
a sensor that measures a grasping state of a grasped object as an identification target;
a position information acquisition unit that acquires position information of a sensor wearer who is wearing the sensor; and
an identification unit that identifies the grasped object that is grasped by the sensor wearer based on the grasping state measured by the sensor and the position information acquired by the position information acquisition unit.)

2. The identification device according to claim 1, further comprising a database where a feature amount indicating the grasping state measured by the sensor is registered by being associated with the position information acquired by the position information acquisition unit for each of a plurality of registration-target objects, wherein the identification unit: narrows the plurality of registration-target objects registered in the database down to one or more candidate objects according to the position information acquired by the position information acquisition unit; and among the one or more narrowed down candidate objects, identifies a single candidate object having the feature amount that corresponds to the feature amount indicating the grasping state of the grasped object measured by the sensor to be the object of the identification target.

3. The identification device according to claim 2, further comprising a learning unit that registers the feature amount to the database in association with the position information acquired by the position information acquisition unit for each of the plurality of registration-target objects.

4. The identification device according to claim 2, wherein:
the feature amount indicating the grasping state measured by the sensor includes a feature amount indicating a frequency characteristic that is based on a vibration propagated through inside of the object;
the sensor generates a first vibration to be given to the object by a piezoelectric element, and acquires a detection signal corresponding to a second vibration that is propagated through the inside of the object out of the first vibration given to the object; and
the identification unit generates a feature amount indicating a frequency characteristic of the second vibration based on the acquired detection signal and, among the plurality of registration-target objects registered in the database, identifies a single candidate object having the feature amount that corresponds to the generated feature amount to be the object of the identification target.

5. The identification device according to claim 4, wherein:
the database stores a model in association with the position information acquired by the position information acquisition unit, the model having the generated feature amount of the grasped object as the identification target as input and outputting a value according to a difference between the feature amount of at least one of the identified registration-target objects and the feature amount of the grasped object in association with an identifier that is uniquely given to the grasped object;
the model is learned based on the feature amount indicating the frequency characteristic of the second vibration generated based on the detection signal acquired by the sensor for each of the plurality of registration-target objects; and
the identification unit inputs the feature amount generated for the grasped object as the identification target to the model of the one or more narrowed down candidate objects, and determines an identifier output by being associated with a value indicating the highest relevance with the feature amount of the grasped object among values output from the model of the one or more candidate objects as the identifier of the grasped object so as to identify the grasped object.

6. The identification device according to claim 1, wherein the position information acquisition unit detects an intensity of a radio signal from a transmission device that transmits the radio signal, and estimates a position with respect to the transmission device based on the detected intensity.

7. The identification device according to claim 1, wherein the position information acquisition unit includes a position detection sensor that detects the position information.

8. The identification device according to claim 1, wherein the position information acquisition unit includes a communication device that receives the position information transmitted from a position information transmission device.

9. An identification method used in an identification device that comprises a processor and a sensor that measures a grasping state of a grasped object as an identification target to identify the grasped object, the identification method comprising:
acquiring, by the processor, position information of a sensor wearer who is wearing the sensor; and
identifying the grasped object that is grasped by the sensor wearer based on the grasping state measured by the sensor and the acquired position information.

10. A non-transitory computer-readable medium having computer-executable instructions that, upon execution of the instructions by a processor of a computer, cause the computer to function as the identification device according to claim 1.
